(19) United States
(12) Patent Application Publication
(10) Pub. No.: US 2026/0347148 A1
(43) Pub. Date: Nov. 5, 2026

(54) ELEVATOR SYSTEM

(71) Applicant: Otis Elevator Company, Farmington, CT (US)

(72) Inventors: Maria Dolores Garcia-Suelto, Leganes (ES); Marcos Marra, Leganes (ES); Salvador Garcia, Leganes (ES)

(21) Appl. No.: 19/652,194

(22) Filed: Apr. 20, 2026

(30) Foreign Application Priority Data
Apr. 30, 2025 (EP) 25382444.5

(51) Int. Cl. B66B 7/02; B66B 7/04; B66B 9/00; B66B 19/00

(52) U.S. Cl. CPC B66B 7/022; B66B 7/021; B66B 7/024; B66B 7/025; B66B 7/046; B66B 9/00; B66B 19/002

(57) ABSTRACT

Elevator system (2) includes a hoistway (4) extending in a longitudinal direction (LD) between a plurality of landings (8); and a guiding structure (22) arranged in the hoistway (4) and extending along the longitudinal direction (LD). The guiding structure (22) includes at least four guide portions, each of the at least four guide portions is configured for guiding the movement of any of an elevator car (6) and a counterweight (16) along the longitudinal direction (LD). The guiding structure (22) is an integrated guiding structure (22) comprising a unitary guiding profile providing the at least four guide portions.

### FOREIGN PRIORITY

This application claims priority to European Patent Application No. 25382444.5, filed Apr. 30, 2025, and all the benefits accruing therefrom under 35 U.S.C. §119, the contents of which in its entirety are herein incorporated by reference.

### TECHNICAL FIELD OF INVENTION

The invention relates to an elevator system comprising a guiding structure for guiding the movement of an elevator car and a counterweight in a hoistway. The invention further relates to a method of installing such a guiding structure in a hoistway of an elevator system.

### BACKGROUND OF THE INVENTION

An elevator system typically comprises at least one elevator car that is configured for moving along a hoistway between a plurality of landings. The elevator system may further comprise at least one counterweight that is configured for moving concurrently with the elevator car in the opposite direction.

Movement of the at least one elevator car and the at least one counterweight is guided by a guiding structure that includes guide members, such as guide rails, extending along a longitudinal direction of the hoistway.

It would be beneficial to provide an improved guiding structure that may be manufactured and installed more easily and at lower costs.

### SUMMARY OF THE INVENTION

According to an exemplary embodiment of the invention, an elevator system comprises a hoistway extending in a longitudinal direction between a plurality of landings; and a guiding structure arranged in the hoistway and extending along the longitudinal direction. The guiding structure comprises at least four guide portions, wherein each of the at least four guide portions is configured for providing at least one guide rail for guiding the movement of any of an elevator car and a counterweight along the longitudinal direction. The guiding structure is an integrated guiding structure. This means that the at least four guide portions may be formed integrally with each other as a single piece. Said single piece may constitute a unitary guiding profile comprising the at least four guide portions.

Exemplary embodiments of the invention further include a method of installing a guiding structure comprising at least four guide portions in a hoistway of an elevator system, wherein each guide portion is configured for guiding an elevator car or a counterweight along the longitudinal direction and wherein the guiding structure is an integrated guiding structure comprising a unitary guiding profile forming the at least four guide portions. The method comprises fixing a lower portion of the guiding structure to a bottom of the hoistway and fixing an upper portion of the guiding structure to a top of the hoistway.

An integrated guiding structure may be manufactured and installed faster, more easily and at lower cost than a conventional guiding structure that is assembled from a plurality of different components.

In the following, a number of optional features of an elevator safety system according to exemplary embodiments of the invention are set out. Unless explicitly stated otherwise, these features may be realized in particular embodiments, alone or in combination with any of the other features.

The integrated guiding structure of an elevator system according to an exemplary embodiment of the invention may be made of metal, in particular made of steel.

Metal, in particular steel, is well suited for forming an integrated guiding structure of an elevator system according to an exemplary embodiment of the invention. Metal, in particular steel, comprises in particular sufficient rigidity for forming integrated guiding structure of an elevator system according to an exemplary embodiment of the invention.

An integrated guiding structure may, for example, be manufactured at low costs by extrusion molding or by roller molding.

The integrated guiding structure may be provided as a single piece extending from the bottom to the top of the hoistway.

Alternatively, the integrated guiding structure may be composed of a plurality of modules, wherein each module extends over a fraction of the height of the hoistway. Adjacent modules may be connected to each other e.g. by welding or by screwing.

The unitary guiding profile may include an H-shaped profile comprising a central leg and four outer legs that are formed integrally with each other as a single piece.

Alternatively, the unitary guiding profile may include a double V-shaped profile or a double U-shaped profile. Such profiles may be formed integrally as single pieces as well.

The guide portions of the integrated guiding structure may be formed at the ends of the four legs of the H-shaped profile or of the double V-shaped profile or the double U-shaped profile, respectively.

Such profiles are well suited for providing integrated guiding structures comprising at least four guide portions for guiding the movement of an elevator car and a counterweight. Such profiles comprise the necessary strength and rigidity and may be manufactured easily at low costs.

The guiding structure may be fixed to the bottom of the hoistway and/or to the top of the hoistway. For facilitating the installation of the guiding structure in the hoistway, the guiding structure may in particular be fixed only to the bottom and to the top, but not to a sidewall, of the hoistway. Fixing the guiding structure only to the bottom and to the top of the hoistway may in particular be sufficient if the height of the hoistway is not too large, for example if the height of the hoistway does not exceed 20 m, in particular if the height of the hoistway does not exceed 15 m.

In order to enhance the stability and rigidity, the guiding structure may additionally be fixed to at least one sidewall of the hoistway. The guiding structure may in particular be fixed to at least one sidewall of the hoistway if the hoistway has a large height, for example a height of more than 15 m.

The guiding structure may be fixed to at least one sidewall of the hoistway at at least one height. The guiding structure may be fixed to at least one sidewall of the hoistway at multiple positions that may be located at different heights.

At least one brace or strut may be employed for fixing the guiding structure to at least one sidewall of the hoistway. The at least one brace or strut may be welded to the guiding structure. It also may be fixed to the guiding structure using bolts or screws. The at least one brace or strut may also be integrated with the guiding structure.

A method of installing a guiding structure according to an exemplary embodiment of the invention may include fixing the guiding structure to at least one sidewall of the hoistway. The method may in particular include employing at least one brace or strut for fixing the guiding structure to the at least one sidewall of the hoistway.

The elevator system may further comprise a ground plate that is mounted to a lower portion of the guiding structure. The ground plate may be welded to the guiding structure. It also may be fixed to the guiding structure using bolts or screws. The ground plate may be arranged on and fixed to the bottom of the hoistway when the guiding structure is installed in the hoistway. The ground plate may be fixed to the bottom of the hoistway by means of screws or bolts extending through openings that are formed within the ground plate. The ground plate may be made of metal, in particular of steel.

The method of installing a guiding structure according to an exemplary embodiment of the invention may include mounting, in particularly welding, a ground plate to the lower portion of the guiding structure and arranging the ground plate at the bottom of the hoistway.

The method of installing a guiding structure according to an exemplary embodiment of the invention may include fixing an upper portion of the guiding structure to an upper end or ceiling of the hoistway. The method may in particular include using brackets for fixing an upper portion of the guiding structure to an upper end or ceiling of the hoistway.

The elevator system may further comprise an elevator machine for driving the elevator car. The elevator machine may be supported by the guiding structure. The elevator machine may, for example, be arranged on an upper portion of the guiding structure. A bedplate may be provided on the upper portion of the guiding structure for supporting the elevator machine.

The elevator system may further comprise an elevator car that is equipped with at least two car guide members. Each of the at least two car guide members may engage with a corresponding one of the guide portions provided by the guiding structure, in particular with a dedicated car guide portion, for guiding the movement of the elevator car in the hoistway along the longitudinal direction.

The elevator system may further comprise a counterweight that is equipped with at least two counterweight guide members. Each of the at least two counterweight guide members may engage with a corresponding one of the guide portions of the guiding structure, in particular with a dedicated counterweight guide portion, for guiding the movement of the elevator car in the hoistway along the longitudinal direction.

Each of the guide members may comprise at least one roller that is configured for rolling along the corresponding guide portion of the guiding structure. Providing the guide members with rollers allows the guide members to move along the corresponding guide portions with only small friction and wear.

### BRIEF DESCRIPTION OF THE DRAWINGS

In the following, exemplary embodiments of the invention are described in more detail with respect to the enclosed figures:

FIG. 1 depicts a schematic view of an elevator system according to an exemplary embodiment of the invention.

FIG. 2 depicts a top view of an elevator car, a counterweight and a guiding structure in a hoistway of an elevator system according to an exemplary embodiment of the invention.

FIG. 3 depicts a perspective view of the guiding structure depicted in FIG. 2.

FIG. 4 depicts an enlarged perspective view of an upper portion of the guiding structure supporting an elevator machine.

### DETAILED DESCRIPTION OF THE INVENTION

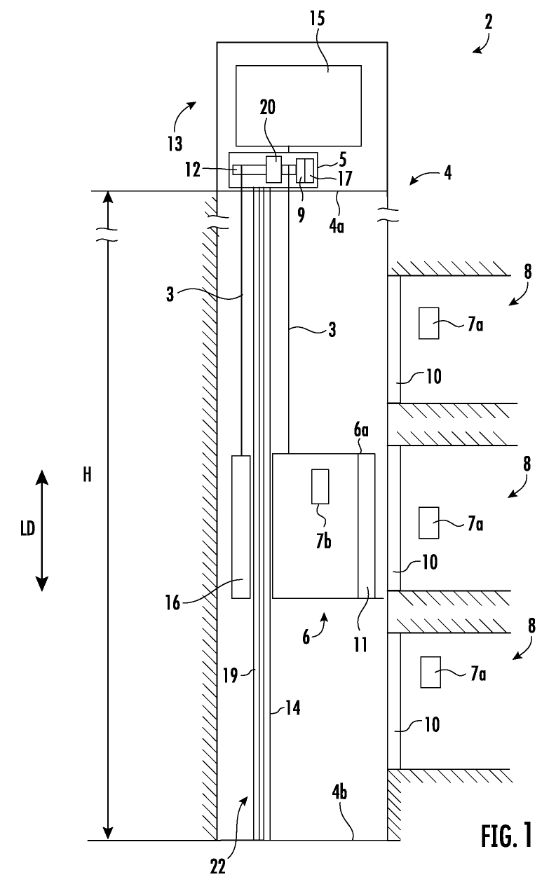

FIG. 1 schematically depicts an elevator system 2 according to an exemplary embodiment of the invention.

The elevator system 2 comprises a hoistway 4 extending along a longitudinal direction LD over a height H between a plurality of landings 8 located on different floors. The elevator system 2 includes an elevator car 6 that is arranged in the hoistway 4 for being moved along the longitudinal direction LD between the plurality of landings 8. The elevator car 6 may in particular be movable along at least one elevator car guide rail 14 provided in the hoistway 4 and extending along the longitudinal direction LD.

The longitudinal direction LD may be oriented in a vertical direction, as it is depicted in FIG. 1. In an alternative embodiment, which is not depicted in the figures, the longitudinal direction LD may be inclined with respect to the vertical direction.

Although only a single elevator car guide rail 14 is depicted in FIG. 1, the elevator system 2 may comprise a plurality of elevator car guide rails 14 extending parallel to each other.

Although only a single elevator car 6 is depicted in FIG. 1, exemplary embodiments of the invention may also include elevator systems 2 comprising a plurality of elevator cars 6 moving in one or more hoistways 4.

The elevator car 6 is movably suspended by means of a tension member 3. Although only a single tension member 3 is depicted in FIG. 1, exemplary embodiments of the invention may also include elevator systems 2 comprising a plurality of tension members 3.

The at least one tension member 3, for example a rope or belt, is coupled to an elevator machine 5. The elevator machine 5 comprises a motor 9 for rotatably driving a shaft 12, and a drive 17 that harnesses and controls the electrical energy supplied to the motor 9. The elevator machine 5 is configured for driving the at least one tension member 3, which is coupled to the shaft 12, e.g. via traction, in order to move the elevator car 6 in the hoistway 4 along the longitudinal direction LD between the plurality of landings 8.

The elevator machine 5 is further provided with at least one elevator brake 20 for braking rotation of the shaft 12 in order to allow for stopping movement of the elevator car 6 and holding the elevator car 6 at a desired position in the hoistway 4.

The elevator system 2 may further comprise a counterweight 16. The counterweight 16 may be attached to the at least one tension member 3 opposite to the elevator car 6 and configured for moving concurrently and in opposite direction with respect to the elevator car 6. The counterweight 16 may move along at least one counterweight guide rail 19 provided in the hoistway 4 and extending along the longitudinal direction LD.

In the exemplary embodiment depicted in FIG. 1, the elevator car 6 and the counterweight 16 are arranged in a cantilever configuration. In such a cantilever configuration, the elevator car guide rails 14 are arranged laterally next to a side of the elevator car 6, and the counterweight guide rails 19 are arranged laterally next to a side of the counterweight 16, respectively.

The elevator car guide rails 14 and the counterweight guide rails 19 are in particular arranged between the elevator car 6 and the counterweight 16.

The elevator car guide rail 14 and the counterweight guide rail 19 may be integrated with each other forming an integrated guiding structure 22.

The integrated guiding structure 22 may be provided as a single piece extending from a bottom 4b to an upper end 4a of the hoistway 4, in particular in case the hoistway 4 has a limited height H.

Alternatively, in particular in case the hoistway 4 has a significant height H, the integrated guiding structure 22 may be composed of a plurality of modules, wherein each module extends over a fraction of the height of the hoistway 4. Adjacent modules may be connected to each other e.g. by welding or by screwing.

The integrated guiding structure 22 may be fixed to the upper end 4a and/or to the bottom 4b of the hoistway 4.

In particular in case the hoistway 4 has a limited height H, for example a height H that does not exceed 15 m, it may be sufficient to fix the guiding structure 22 only to the upper end 4a and to the bottom 4b of the hoistway 4. It may, in particular, not be necessary to fix the guiding structure 22 to one of the sidewalls of the hoistway 4.

The at least one tension member 3 may be a rope, e.g. a steel cord, or a belt, in particular a coated steel belt. The at least one tension member 3 may be uncoated. Alternatively, the at least one tension member 3 may be coated with a coating, e.g. with a coating having the form of a polymer jacket. In a particular embodiment, the at least one tension member 3 may be a belt comprising a plurality of polymer coated steel cords (not shown). The elevator system 2 may have a traction drive including a traction sheave for driving the at least one tension member 3.

In the exemplary embodiment depicted in FIG. 1, a 1:1 roping is employed for suspending the elevator car 6. The type of the roping is, however, not essential for the invention and different kinds of roping, e.g. a 2:1 roping or a 4:1 roping may be employed as well.

A landing door 10 is provided at each of the landings 8. The elevator car 6 is provided with a corresponding elevator car door 11 for allowing passengers to transfer between a landing 8 and the interior of the elevator car 6, when the elevator car 6 is positioned at the respective landing 8.

For moving the elevator car 6 along the hoistway 4 between the different landings 8, the elevator machine 5 may be controlled by an elevator controller 15 of the elevator system 2.

The elevator system 2 may be a machine room-less elevator system 2. In an alternative embodiment, the elevator system 2 may comprise a machine room 13 housing the elevator machine 5 and the elevator controller 15.

Input to the elevator controller 15 may be provided via landing control panels 7a provided on every landing 8, in particular in the vicinity of the landing doors 10, and/or via an elevator car control panel 7b provided inside the elevator car 6.

The landing control panels 7a may comprise elevator hall call buttons and/or destination call buttons. Destination call buttons allow passengers to enter their respective destinations before entering the elevator car 6. In case the landing control panels 7a are equipped with destination call buttons, no elevator car control panel 7b needs to be provided inside the elevator car 6 since the elevator system 2 is fully controlled by the commands input via the landing control panels 7a.

The landing control panels 7a and the elevator car control panel 7b may be coupled with the elevator controller 15 by means of electrical wiring not shown in FIG. 1, in particular by an electric bus, or by wireless data connections.

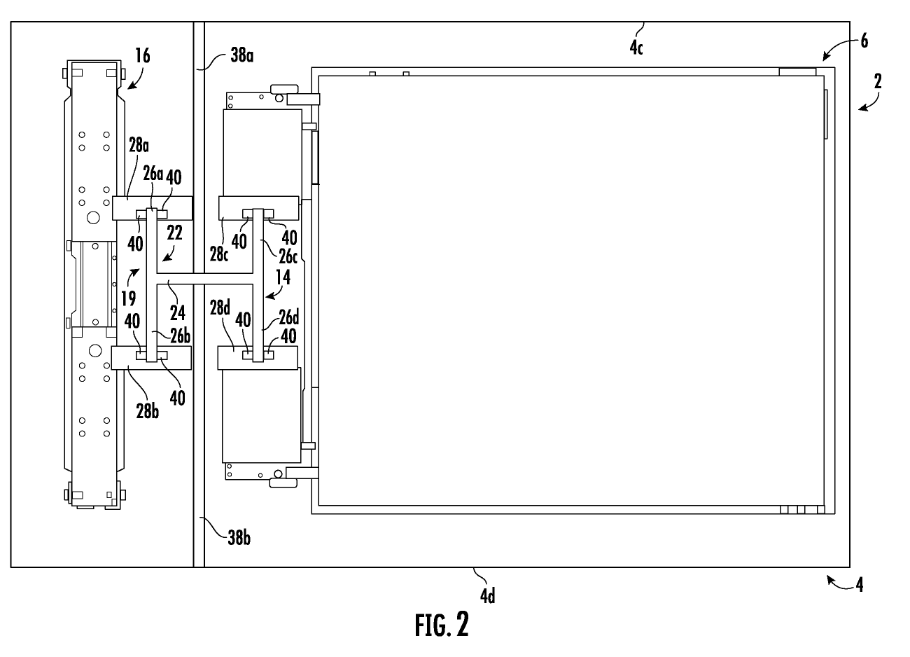

FIG. 2 depicts a top view of a hoistway 4 of an elevator system 2 according to an exemplary embodiment of the invention with the longitudinal direction LD extending perpendicularly to the plane of view depicted in FIG. 2.

The elevator system 2 depicted in FIG. 2 comprises an elevator car 6, a counterweight 16 and a guiding structure 22 providing the elevator car guide rail 14 and the counterweight guide rail 19.

The elevator car 6 and the counterweight 16 are movably coupled to the guide rails 14, 19 provided by the guiding structure 22 so that the guiding structure 22 guides the movement of the elevator car 6 and the counterweight 16 along the longitudinal direction LD.

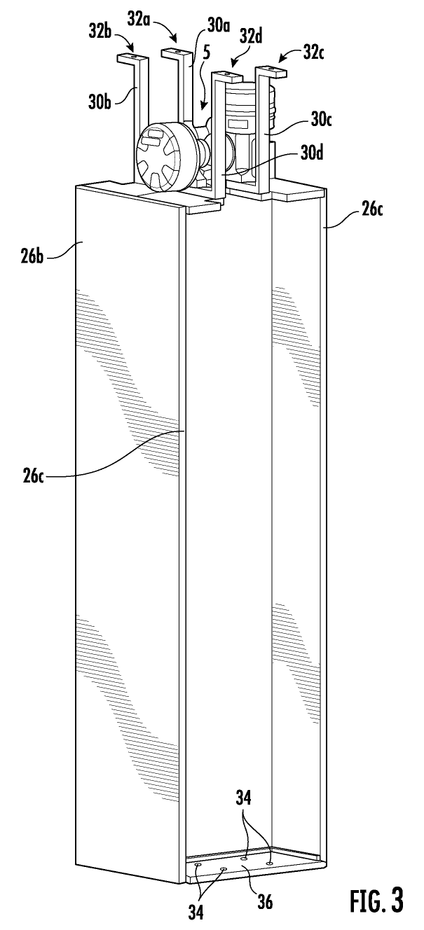

FIG. 3 depicts a perspective view of the guiding structure 22.

In the exemplary embodiment depicted in FIGS. 2 and 3, the guiding structure 22 is provided as an H-shaped profile comprising a central leg 24 and four outer legs 26a-26d extending perpendicularly from each of the two ends of the central leg 24, respectively.

The central leg 24 and the four outer legs 26a-26d are formed integrally with each other as a single piece providing a unitary guiding profile. The unitary guiding profile includes guide portions for guiding the movement of guide members 28a-28d that are provided at the elevator car 6 and at the counterweight 16.

In the exemplary embodiment depicted in FIGS. 2 and 3, the guide portions are located at the ends of the four outer legs 26a-26d of the integrated guiding structure 22.

The H-shape of the guiding structure 22 depicted in FIGS. 2 and 3 is only exemplary. In further embodiments, which are not explicitly depicted in the figures, the integrated guiding structure 22 may, for example, include a V-shaped profile or a double U-shaped profile, respectively. Such V-shaped or a double U-shaped profiles may be integrated guiding structures 22 in which all legs are provided by a single piece.

The top view depicted in FIG. 2 shows two counterweight guide members 28a, 28b that are mounted to the counterweight 16 and that are in engagement with corresponding counterweight guide portions that are formed by two outer legs 26a, 26b of the integrated guiding structure 22.

FIG. 2 further shows two car guide members 28c, 28d that are mounted to the elevator car 6 and that are in engagement with corresponding car guide portions provided by the two other outer legs 26c, 26d of the integrated guiding structure 22.

The elevator car 6 and the counterweight 16 may be equipped with additional guide members 28a-28d that are not visible in FIG. 2 since they are arranged below and thus covered by the guide members 28a-28d depicted in FIG. 2.

The guide members 28a-28d may be provided as guide shoes that are configured for sliding along the corresponding guide portions provided by the outer legs 26a-26d of the integrated guiding structure 22 when the elevator car 6 and the counterweight 16 move along the longitudinal direction LD.

Optionally, each of the guide members 28a-28d may be equipped with at least one roller 40 that is configured for rolling along the corresponding guide portion of the integrated guiding structure 22 when the elevator car 6 and the counterweight 16 move within the hoistway 4 along the longitudinal direction LD. Providing rollers 40 at the guide members 28a-28d may reduce the friction, wear and noise generated by the movement of the guide members 28a-28d along the guide portion of the integrated guiding structure 22.

The elevator machine 5 may be supported by the integrated guiding structure 22. The elevator machine 5 may in particular be arranged on an upper portion of the integrated guiding structure 22, as it is depicted in FIG. 3.

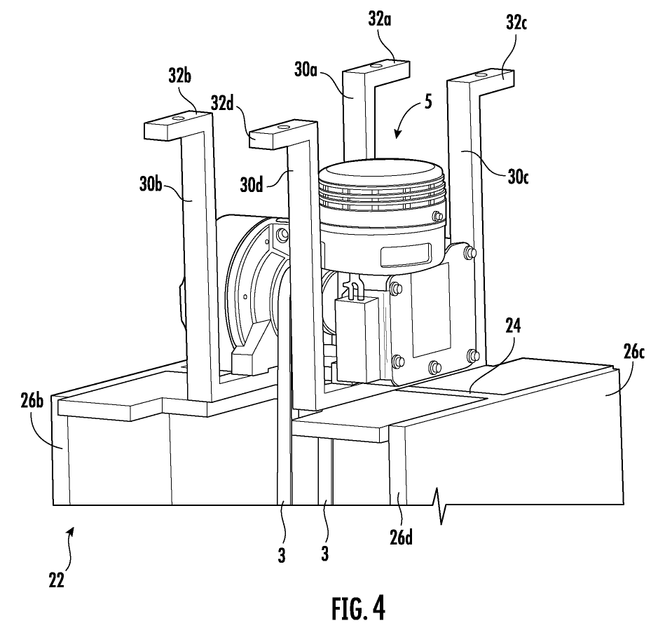

FIG. 4 depicts an enlarged perspective view of the elevator machine 5 arranged on the upper portion of the integrated guiding structure 22.

In the exemplary embodiment depicted in FIGS. 3 and 4, the integrated guiding structure 22 is equipped with four brackets 30a-30d. The four brackets 30a-30d extend vertically upward from the top of the integrated guiding structure 22 beyond the elevator machine 5. Upper end portions 32a-32d of the brackets 30a-30d extend basically horizontally parallel to the upper end 4a or ceiling of the hoistway 4. The upper end portions 32a-32d of the brackets 30a-30d are configured for being mounted to the upper end 4a or ceiling (see FIG. 1) of the hoistway 4 for fixing the upper end of the integrated guiding structure 22 in the hoistway 4. Bolts and/or screws may be employed for fixing the upper end portions 32a-32d of the brackets 30a-30d to the upper end 4a or ceiling of the hoistway 4.

In the exemplary embodiment depicted in FIG. 3, a ground plate 36 is mounted to a lower end of the integrated guiding structure 22. The ground plate 36 may, for example, be welded, soldered or screwed to the lower end of the integrated guiding structure 22.

The ground plate 36 may be arranged on the bottom or floor 4b (see FIG. 1) of the hoistway 4, when the integrated guiding structure 22 is arranged in the hoistway 4. The ground plate 36 may be fixed to the bottom or floor 4b of the hoistway 4 using bolts or screws (not shown) that extend though fixing openings 34 formed in the ground plate 36.

To enhance the stability of the integrated guiding structure 22, particularly when the hoistway 4 and the integrated guiding structure 22 have a significant height H along the longitudinal direction LD, the integrated guiding structure 22 may additionally be secured to at least one side wall 4c, 4d of the hoistway 4.

As depicted in FIG. 2, the elevator system 2 may, for example, comprise at least one strut or brace 38a, 38b extending between the integrated guiding structure 22, in particular the central leg 24 of the integrated guiding structure 22, and at least one sidewall 4c, 4d of the hoistway 4 for providing a mechanical connection between the integrated guiding structure 22 and the at least one sidewall 4c, 4d of the hoistway 4.

For enhancing the stability of the integrated guiding structure 22 even further, a plurality of struts or braces 38a, 38b may be installed at various heights within the hoistway 4.

While the invention has been described with reference to exemplary embodiments, it will be understood by those skilled in the art that various changes may be made and equivalents may be substituted for elements thereof without departing from the scope of the invention. In addition, many modifications may be made to adopt a particular situation or material to the teachings of the invention without departing from the essential scope thereof. Therefore, the invention is not intended to be limited to the specific embodiments disclosed, but to encompass all embodiments within the scope of the appended claims.

What is claimed is:

1. Elevator system (2) comprising:
a hoistway (4) extending in a longitudinal direction (LD) between a plurality of landings (8); and
a guiding structure (22) arranged in the hoistway (4) and extending along the longitudinal direction (LD);
wherein the guiding structure (22) comprises at least four guide portions, and wherein each of the at least four guide portions is configured for guiding the movement of any of an elevator car (6) and a counterweight (16) along the longitudinal direction (LD); and
wherein the guiding structure (22) is an integrated guiding structure (22) comprising a unitary guiding profile providing the at least four guide portions.

2. Elevator system (2) according to claim 1, wherein the integrated guiding structure (22) is made of metal, wherein the integrated guiding structure (22) is in particular made of steel.

3. Elevator system (2) according to claim 1, wherein the integrated guiding structure (22) includes an H-shaped profile or a double V-shaped profile or a double U-shaped profile, and wherein the guide portions are formed at the ends of the four legs of the H-shaped profile or of the double V-shaped profile or the double U-shaped profile, respectively.

4. Elevator system (2) according to claim 1, wherein the integrated guiding structure (22) is fixed to the bottom (4b) of the hoistway (4) and/or to and upper end (4a) of the hoistway (4).

5. Elevator system (2) according to claim 4, wherein the integrated guiding structure (22) is fixed only to the bottom (4b) and to the upper end (4a), but not to a sidewall (4c, 4d), of the hoistway (4).

6. Elevator system (2) according to claim 1, wherein the integrated guiding structure (22) is fixed to at least one sidewall (4c, 4d) of the hoistway (4).

7. Elevator system (2) according to claim 6, further comprising at least one brace (38a, 38b) fixing the integrated guiding structure (22) to at least one sidewall (4c, 4d) of the hoistway (4).

8. Elevator system (2) according to claim 1, further comprising a ground plate (36) that is mounted, in particularly welded, to a lower portion of the integrated guiding structure (22).

9. Elevator system (2) according to claim 1, further comprising an elevator machine (5) for driving the elevator car (6), wherein the elevator machine (5) is supported by the integrated guiding structure (22); wherein the elevator machine (5) is in particular arranged on an upper portion of the integrated guiding structure (22).

10. Elevator system (2) according to claim 1, further comprising an elevator car (6) equipped with at least two car guide members (28c, 28d), wherein each of the at least two car guide members (28c, 28d) engages with a corresponding one of the guide portions for guiding the movement of the elevator car (6) in the hoistway (4) along the longitudinal direction (LD).

11. Elevator system (2) according to claim 1, further comprising a counterweight (16) equipped with at least two counterweight guide members (28a, 28b), wherein each of the at least two counterweight guide members (28a, 28b) engages with a corresponding one of the guide portions of the integrated guiding structure (22) for guiding the movement of the elevator car (6) in the hoistway (4) along the longitudinal direction (LD).

12. Elevator system (2) according to claim 10, wherein each guide member (28a-28d) comprises at least one roller (40) that is configured for rolling along the corresponding guide portion of the integrated guiding structure (22).

13. Method of installing a guiding structure (22) comprising at least four guide portions in a hoistway (4) of an elevator system (2),
wherein each guide portion is configured for guiding an elevator car (6) or a counterweight (16) along the longitudinal direction (LD);
wherein the guiding structure (22) is an integrated guiding structure (22) comprising a unitary guiding profile providing the at least four guide portions
wherein the method comprises fixing a lower portion of the integrated guiding structure (22) to a bottom (4b) of the hoistway (4) and fixing an upper portion of the integrated guiding structure (22) to an upper end (4a) of the hoistway (4).

14. Method according to claim 13,
wherein the method further includes fixing the integrated guiding structure (22) to at least one sidewall (4c, 4d) of the hoistway (4);
wherein the method in particular includes employing at least one strut or brace (38a, 38b) for fixing the integrated guiding structure (22) to the at least one sidewall (4c, 4d) of the hoistway (4).

15. Method according to claim 13, wherein the method further includes
mounting, in particularly welding, a ground plate (36) to the lower portion of the integrated guiding structure (22) and arranging the ground plate (36) at the bottom (4b) of the hoistway (4); and/or
fixing an upper portion of the integrated guiding structure (22) to an upper end (4a) of the hoistway (4); the method may in particular include using brackets (30a-30d) for fixing an upper portion of the integrated guiding structure (22) to the upper end (4a) of the hoistway (4).
